(19) United States
(12) Patent Application Publication
(10) Pub. No.: US 2012/0137301 A1
(43) Pub. Date: May 31, 2012

(54) RESOURCE UTILIZATION MANAGEMENT FOR A COMMUNICATION DEVICE

(75) Inventors: Thomas K. Roslak, Northport, NY (US); Varma L. Chanderraju, San Jose, CA (US); Brian J. Frommelt, Deer Park, IL (US)

(73) Assignee: SYMBOL TECHNOLOGIES, INC., Schaumburg, IL (US)

(21) Appl. No.: 12/957,248

(22) Filed: Nov. 30, 2010

(51) Int. Cl. G06F 9/46

(52) U.S. Cl. 718/103

(57) ABSTRACT

A technique for resource utilization management for a communication device includes provisioning 500 priority applications to be run in a priority mode on the communication device, triggering 502 a priority mode for the communication device, and minimizing 504 resources to any applications on the communication device that are not provisioned priority applications.

### FIELD OF THE DISCLOSURE

The present invention relates generally to communication devices and more particularly to dual-mode operation of a communication device.

### BACKGROUND

A significant trend is for a business owner is to subsidize their employees' communication devices and calling plans. This is done in the hope that an employee will use the communication device for business purposes, such as for accessing computing and communication resources and facilities related to work applications. However, it is also a common occurrence for employees to access the computing and communication resources and facilities of the business for personal use, which does not benefit the company. Employees may want to use these resources as they see fit, such as using a personal social networking application during work hours, for example. This can adversely affect resource utilization for the communication device, and might not be considered appropriate by the employer which is subsidizing the communication device and its connectivity. In addition, an employee may feel that there is no harm in using the communication device for personal use outside of work as the employer is only paying a subsidy. These personal actions may still affect business operations and could be a detriment to the business.

One solution to the problem is to provide a mode setting on the communication device to switch between a work and a play mode, or between a computer and user mode. However, this solution is a manual solution and is controlled by the user, which still leaves the employer exposed to unauthorized resource utilization incurred by the user.

Another problem with resource utilization for a communication device is that current general purpose computing and operating systems allow multiple applications to run on a communication device. These applications are often created without knowledge of what other applications, management or resource overheads are incurred by the computing platform of the device. In addition, many operating systems provide resource management in a non-specific manner in an attempt to spread resources such as computing power, memory and I/O to keep the overall system operating. It is possible for such operating systems to become overloaded, which slows down, and could possibly disable a communication device as resources are distributed over too many applications.

Accordingly, there is a need for a business to manage resources utilized by an employee's communication device. It would be of further benefit if this resource management could be performed automatically. It would also be desirable to control the resources of the device to operate critical applications regardless of other applications that may be requesting resources without disabling the functionality of the communication device.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of a system, in accordance with some embodiments of the present invention.

FIG. 2 is a flowchart of a method, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A system and method is described to automatically manage resources utilized by an employee's communication device, in accordance with the present invention. One aspect of the present invention allows the communication device to be put into “priority mode” that restricts the resources available to the communication device. Optionally, performance of critical activities could be maximized on the mobile device while the device is in priority mode. It is envisioned that “priority mode” could be activated by a time scheduling system, a location-based trigger, user selection, or by the scanning of a bar code. Although the “priority mode” could be used to lock down the communication device to run only priority applications, such as in a business mode, the present invention could allow a user to use the communication device in a “personal mode” that is strictly a personal responsibility of the employee. Another aspect of the present invention controls the resources of the device to operate critical applications regardless of other applications that may be requesting resources without disabling the functionality of the communication device.

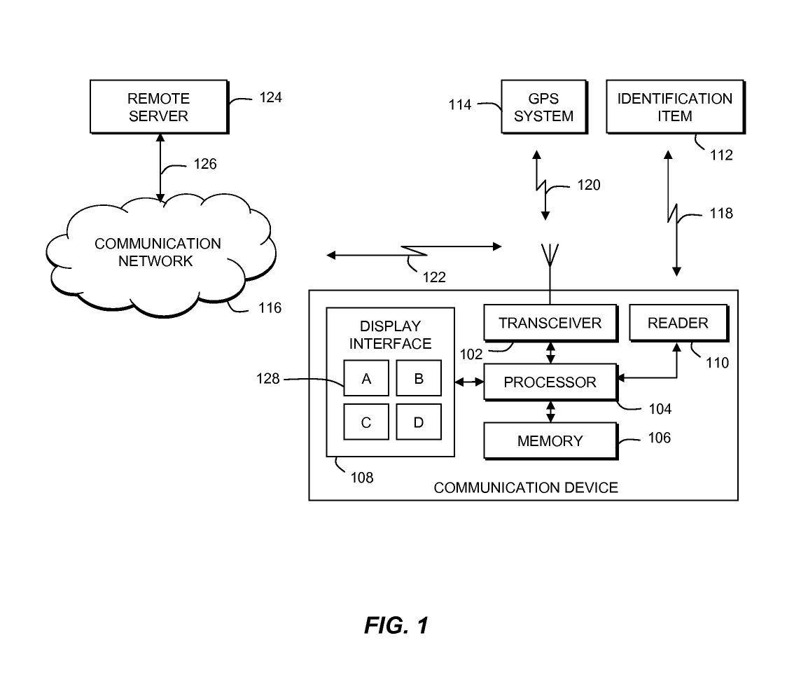

FIG. 1 is a block diagram depiction of a system in accordance with the present invention. A communication device 100 includes a transceiver 102 adapted to transceiver various wireless communication signals, a memory 106, and a display interface 108. The transceiver, memory, and display interface are under the control of a processor 104. The device can also include an optional scanner or reader 110 device, such as a barcode reader and/or radio frequency identification tag reader, under control of the processor 104. The device is also operable to provide telephone communications 122 with a communication network 116, as is known in the art. The device is able to run priority, business and personal software applications that can be stored in the memory 106 and/or downloaded 126 from a remote server 124. Optionally, the device is able to receive location services 120 from a system such as a global positioning system, network triangulation, and the like, 114 using the transceiver 102 or secondary transceiver (not shown) as is known in the art. Further, the device can read 118 identification items 112, such as a barcode and/or radio frequency identification tag, if the device has the optional reader 110, such as a barcode reader and/or radio frequency identification tag reader, respectively, as are known in the art.

Communication devices refer to a wide variety of electronic platforms such as cellular radiotelephones, user equipment, subscriber stations, access terminals, remote terminals, terminal equipment, cordless handsets, gaming devices, mobile computers, and personal digital assistants, and the like, all referred to herein as devices. Each device comprises a processor that can be further coupled to a keypad, a speaker, a microphone, a display, and other features, as are known in the art and therefore not shown.

Referring back to FIG. 1, there is shown a block diagram of various entities adapted to support the inventive concepts of the preferred embodiments of the present invention. Those skilled in the art will recognize that FIG. 1 does not depict all of the equipment necessary for system to operate but only those system components and logical entities particularly relevant to the description of embodiments herein. In general, components such as processors, transceivers, memories, and display interfaces are well-known. For example, processing units are known to comprise basic components such as, but not limited to, microprocessors, microcontrollers, memory cache, application-specific integrated circuits (ASICs), and/or logic circuitry. Such components are typically adapted to implement algorithms and/or protocols that have been expressed using high-level design languages or descriptions, expressed using computer instructions, expressed using messaging logic flow diagrams.

Thus, given a software application, an algorithm, a logic flow, a messaging/signaling flow, and/or a protocol specification, those skilled in the art are aware of the many design and development techniques available to implement a processor that performs the given logic. Therefore, the entities shown represent a known system that has been adapted, in accordance with the description herein, to implement various embodiments of the present invention. Furthermore, those skilled in the art will recognize that aspects of the present invention may be implemented in and across various physical components and none are necessarily limited to single platform implementations. It is within the contemplation of the invention that the operating requirements of the present invention can be implemented in software, firmware or hardware, with the function being implemented in a software processor (or a digital signal processor) being merely a preferred option.

Referring back to FIG. 1, a communication device 100 having resource utilization management is shown. A memory 106 is provided for storing provisioned priority-related software applications to be run in a priority mode on the communication device. Preferably, the priority applications (e.g. business applications) are provisioned to be run in an exclusive mode on the communication device. Such priority applications represent certified applications that are well characterized, highly tested, validated and approved for use on the device. These applications could come pre-installed on the device or available for after-market install from a certified and approved remote application store. These applications could require a one-time purchase or recurring subscription fees. Moreover, these applications can indicate their required resources and which (if any) other applications that are considered companions and that have been tested and certified to co-exist without conflict on the device. Although a user may assume that there are other applications that are considered critical to a priority use case, and that the user may wish to use untested, unregistered and uncertified applications that may provide a useful purpose, the present invention considers that, while these applications may be appropriate, they have not been tested or validated for use in conjunction with other critical applications, such as business applications. All applications that are not explicitly certified for use in exclusive mode, other than those that are critical for operating the device, will not be eligible to be run when the device transitions to exclusive priority mode operation.

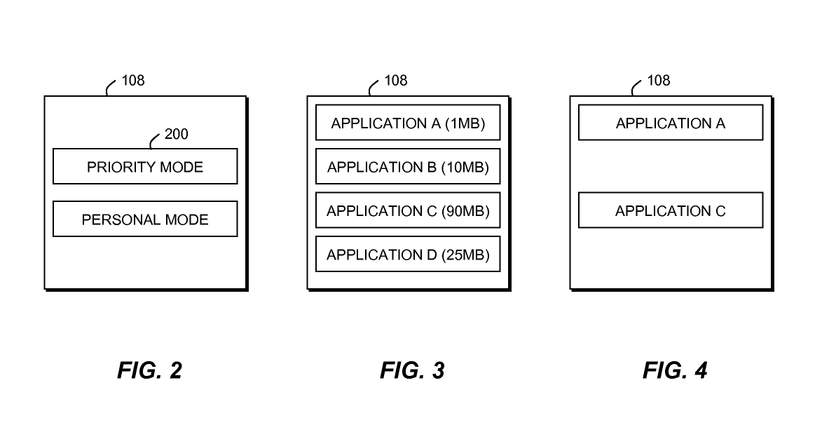

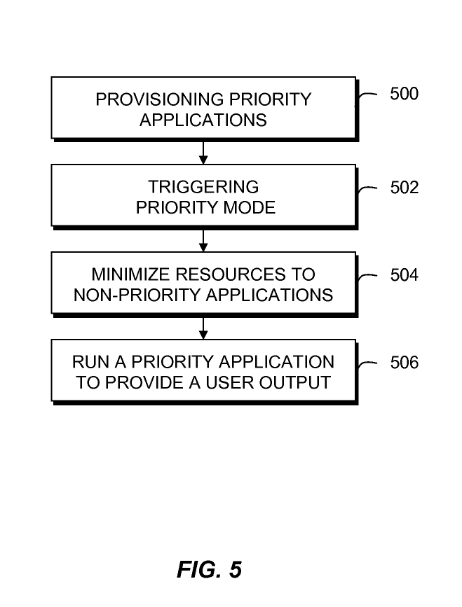

A processor 104 is coupled to the memory and is operable to receive a trigger for triggering a priority mode for the communication device. Different triggering mechanisms could trigger the transition to priority mode operation. In one embodiment, a display interface (108) coupled to the processor, such as is shown in FIG. 2, wherein the trigger is provided by a user manually entering priority mode 200 on the display interface of communication device. The display interface 108, under direction of the processor, can then present the user of the communication device with a list of the defined priority applications for selection by the user, as shown in FIG. 3, wherein the list can also indicate the resources that would be utilized by each application, and wherein the user selects at least one priority application on the display interface to be run on the communication device. In this case, four applications are shown, and an example of their memory resource utilization is shown. It should be recognized that any other resource utilization for the application could be shown such as required bandwidth, required data rate, required quality of service, etc. Optionally, the list can also indicate which defined priority applications can be run together on the communication device safely, and the selecting substep limits selected priority applications to those that can be run together on the communication device safely, such as is shown in FIG. 4, where only priority applications A and C are able to run together on the device safely. It should be recognized that the user can be given an option to safely exit all non-priority applications that are currently operational but not required to execute the chosen priority process. If the user fails to do so the device will take the necessary steps to safely terminate all non-priority applications that are not essential to the priority process about to be executed. Of course, a user could enter a personal mode of operation (see FIG. 2) where the device could operate using untested applications.

In another embodiment, triggering occurs upon detecting that the communication device is in a predetermined location, such as by using a global positioning system, network triangulation, time-of-arrival signals, and the like, and can also include a predetermined time period for triggering priority mode. For example, a person may be employed at a retail establishment, and the communication device could be limited to running business application when that person is located at work during their work hours. However, that person may wish to visit that establishment off hours. In that case, it would be appropriate for the user of the device to have personal control of the device when shopping during their off work hours.

In yet another embodiment, a reader 110 is coupled to the processor. Triggering occurs upon reading a particular identification item that is associated with the priority retail applications. For example, the reader can be a barcode reader or radio frequency identification reader that is able to read a barcode or tag, respectively. The identification item can be associated with a particular retail location or can be used to select a retail mode of the device. This could be used as an approach to allow a user to use their communication device to shop in a store. Their connection would be created by reading a bar code that is dynamically displayed at an entrance unit to the store. This secure authentication method would then put the device into priority mode to run a shopping program. In particular, a consumer's device could have a shopping application that is triggered when the consumer enters a store (or the trigger could be reading the barcode or RFID tag). In this case, it may not be desirable to turn off all other applications but enough could be turned off (or suggested to the user for what should be turned off) to ensure that the shopping applications can run with the best possible performance.

In yet another embodiment, a user may want to play a graphics intensive game application on the device, and does not want performance negatively impacted by other applications. In this case, the user can trigger a priority gaming mode to ensure that game performance is maximized.

If different triggering mechanisms are accepted, the present invention can use the different triggering mechanisms to limit the priority applications that can be run into different subsets. For example, if the trigger is in response to a particular location and time, the device may know that only applications A and C are appropriate for business use, and only present these business applications to the user (as shown in FIG. 4 for example). Other triggers can should different applications such as application B or D, for example.

Upon receipt of the priority mode trigger, the processor then minimizes resources to any applications in the memory of the communication device that are not provisioned priority applications, i.e. non-priority or personal untested and uncertified applications. Preferably, any applications on the communication device that are not provisioned and certified priority applications are terminated on the communication device. More preferably, any telephone communication capabilities of the communication device are not minimized or terminated, because it is desired that the device always retain its basic communication capabilities.

The processor can then run one or more of the selected priority applications to provide an output from the device to the user. This can include displaying results of the output of the application to the user on a display of the device, audio output of the results to the user, or wired or wireless transmission of the output results to the user or another device or person, etc.

FIG. 5 illustrates a flowchart of a method for resource utilization management for a communication device, in accordance with the present invention.

The method includes provisioning 500 priority-related software applications (e.g. business applications) to be run in a priority mode on the communication device. Preferably, the priority applications are provisioned to be run in an exclusive mode on the communication device.

The method also includes triggering 502 a priority mode for the communication device. Triggering can occur using different triggering mechanisms. In one embodiment, triggering 502 includes: manually entering priority mode by a user on the communication device, presenting the user of the communication device with a list of the defined priority applications for selection by the user, wherein the list also indicates the resources that would be utilized by each application, and selecting at least one priority application to be run on the communication device by the user. Optionally, the list can also indicate which defined priority applications can be run together on the communication device safely, and the selecting substep limits selected priority application to those that can be run together on the communication device safely. In another embodiment, triggering occurs upon detecting that the communication device is in a predetermined location, such as by using a global positioning system, at a predetermined time. In yet another embodiment, triggering occurs upon reading a particular identification item that is associated with the priority applications. If different triggering mechanisms are accepted, the present invention can use the different triggering mechanisms to limit the priority applications that can be run into different subsets.

The method also includes minimizing 504 resources to any applications on the communication device that are not provisioned priority applications. Preferably, any applications on the communication device that are not provisioned priority applications, i.e. non-priority or personal applications, are terminated on the communication device. More preferably, any telephone communication capabilities of the communication device are not minimized or terminated.

The method also includes running 506 a selected priority application to provide an output from the device to the user. This can include displaying results of the output of the application to the user on a display of the device, audio output of the results to the user, wired or wireless transmission of the output results to the user or another device or person, and the like.

Advantageously, the system and method described herein can automatically (or manually) manage resources utilized by an employee's communication device. The present invention also controls the resources of the communication device to operate critical applications regardless of other applications that may be requesting resources without disabling the functionality of the communication device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for resource utilization management for a communication device, the method comprising:
provisioning priority applications to be run in a priority mode on the communication device;
triggering a priority mode for the communication device; and
minimizing resources to any applications on the communication device that are not provisioned priority applications.

2. The method of claim 1, wherein minimizing resources includes terminating any applications on the communication device that are not defined priority applications.

3. The method of claim 1, wherein minimizing resources excludes any communication capabilities of the communication device.

4. The method of claim 1, wherein triggering includes:
manually entering priority mode by a user on the communication device,
presenting the user of the communication device with a list of the defined priority applications for selection by the user, wherein the list also indicates the resources that would be utilized by each application, and
selecting at least one priority application to be run on the communication device.

5. The method of claim 4, wherein the list also indicates which defined priority applications can be run together on the communication device safely, and selecting limits selected priority application to those that can be run together on the communication device safely.

6. The method of claim 1, wherein triggering includes triggering a priority mode of the communication device upon detecting that the communication device is in a predetermined location.

7. The method of claim 1, wherein triggering includes reading an identification item that controls entry into priority mode.

8. The method of claim 1, wherein triggering include different triggering mechanisms, wherein each triggering mechanism limits the priority applications that can be run into different subsets.

9. A method for resource utilization management for a communication device, the method comprising:
provisioning business applications to be run in an exclusive mode on the communication device;
triggering a business mode for the communication device; and
terminating any applications on the communication device that are not defined business applications, excluding any telephone communication capabilities.

10. A communication device having resource utilization management comprising:
a memory for storing provisioned priority applications to be run in a priority mode on the communication device;
a processor coupled to the memory, the processor operable to receive a trigger for triggering a priority mode for the communication device, whereupon the processor minimizes resources to any applications in the memory of the communication device that are not provisioned priority applications.

11. The device of claim 10, wherein the processor minimizes resources by terminating any applications on the communication device that are not defined priority applications.

12. The device of claim 10, wherein the processor minimizes resources excluding any communication capabilities of the communication device.

13. The device of claim 10, further comprising a display interface coupled to the processor, wherein the trigger is provided by a user manually entering priority mode on the display interface of communication device, the display interface, under direction of the processor, presents the user of the communication device with a list of the defined priority applications for selection by the user, wherein the list also indicates the resources that would be utilized by each application, and wherein the user selects at least one priority application on the display interface to be run on the communication device.

14. The device of claim 13, wherein the list also indicates which defined priority applications can be run together on the communication device safely, and the processor limits selected priority application to those that can be run together on the communication device safely.

15. The device of claim 10, wherein the trigger occurs upon the processor detecting that the communication device is in a predetermined location.

16. The device of claim 10, further comprising a reader coupled to the processor, the reader that providing the trigger to enter priority mode upon reading a particular identification item.

17. The device of claim 10, wherein the trigger can be provided by different triggering mechanisms, wherein each triggering mechanism limits the priority applications that can be run into different subsets.

18. The device of claim 10, wherein the priority mode is a business mode, and wherein the priority applications are business applications.
